(19) United States
(12) Patent Application Publication
(10) Pub. No.: US 2026/0010585 A1
(43) Pub. Date: Jan. 8, 2026

(54) METHOD AND SYSTEM FOR EVALUATING NEIGHBOURHOOD AGING SUITABILITY BASED ON MULTI-SOURCE DATA FUSION

(71) Applicant: HARBIN INSTITUTE OF TECHNOLOGY (SHENZHEN), Shenzhen (CN)

(72) Inventor: Tianyao ZHANG, Shenzhen (CN)

(73) Assignee: HARBIN INSTITUTE OF TECHNOLOGY (SHENZHEN), Shenzhen (CN)

(21) Appl. No.: 18/730,942

(22) PCT Filed: Apr. 29, 2024
(86) PCT No.: PCT/CN2024/090502

§ 371 Date: Jul. 22, 2024

(30) Foreign Application Priority Data
May 6, 2023 (CN) 202310503841.3

(51) Int. Cl. G06F 18/25; G06F 18/22; G06Q 50/26; G06V 20/52; G06V 40/16

(52) U.S. Cl. CPC G06F 18/251; G06F 18/22; G06V 20/53; G06V 40/172; G06V 40/178; G06Q 50/26; G06V 2201/07

(57) ABSTRACT

A method and a system for evaluating neighbourhood aging suitability based on multi-source data fusion are provided, the method includes: detecting a quantity of people entering and leaving a target neighbourhood; analyzing traffic suitability of the target neighbourhood; evaluating leisure facility perfection of the target neighbourhood; analyzing microenvironment suitability of the target neighbourhood; evaluating aging suitability of the target neighbourhood; and processing the target neighbourhood. The embodiments include analyzing a traveling quantity of elderly people to remedy a defect of low attention paid to the traveling quantity of elderly people, thereby ensuring the accuracy of the analysis results of neighbourhood traffic convenience and improving the accuracy of a neighbourhood aging evaluation.

### FIELD OF THE DISCLOSURE

The present disclosure relates to the technical field of neighbourhood aging suitability evaluation, in particular to a method and a system for evaluating neighbourhood aging suitability based on multi-source data fusion.

### BACKGROUND

With the development of society, the elderly population is gradually increasing, and improving the happiness of the elderly is gradually put on the agenda. Building and developing aging-suitable natural aging neighbourhoods is a low-cost path to achieve healthy aging. Developing and building a neighbourhood environment with high aging suitability is of great significance to improve the satisfaction of neighbourhood pension and achieve healthy aging. In the prior art, most neighbourhoods ignore the consideration of neighbourhood aging suitability in initial construction, which leads to low aging suitability of the neighbourhood. It is difficult to ensure the physical and mental health of the elderly in the neighbourhood, so it is necessary to carry out aging transformation in the neighbourhood. In the process of neighbourhood aging suitability transformation, it is very necessary to analyze the current neighbourhood aging suitability.

The analysis of the neighbourhood aging suitability in the prior art can meet the current demand to a certain extent, but there are still some defects, which are reflected in the following aspects: (1) In the prior art, the attention paid to the travel quantity of the elderly is not high, and the travel quantity of the elderly reflects the travel intention of the elderly to a certain extent, which is the influence level of neighbourhood traffic convenience, and the neglect of this level in the prior art leads to inaccurate analysis results of neighbourhood traffic convenience. Furthermore, it is difficult to ensure the accuracy of the evaluation of neighbourhood aging suitability, and there may be a phenomenon that the evaluation of neighbourhood aging suitability is wrong, which makes it difficult to ensure the correctness of the subsequent neighbourhood aging suitability transformation and reduce the efficiency of neighbourhood aging suitability transformation to a certain extent.

(2) The prior art mostly analyzes the bus stations and subway stations in the neighbourhood, and pays little attention to the bus lines and the quantity of nodes of the bus lines. The prior art ignores this aspect, which makes it difficult to ensure the location of the neighbourhood in an area with convenient transportation. There may be a phenomenon that the neighbourhood includes bus stations but there are fewer bus lines or fewer nodes, which is not conducive to the travel of the elderly, which is not conducive to balancing the relationship between neighbourhood transportation convenience and aging suitability, thus reducing the accuracy of the analysis results of neighbourhood aging suitability.

(3) The analysis of neighbourhood microenvironment when analyzing neighbourhood aging suitability in the prior art is not deep enough, and the neighbourhood microenvironment affects the health of the elderly. The neglect of this aspect in the prior art can not guarantee the health of the elderly when they reside, so it is difficult to guarantee the accuracy and rationality of the evaluation of neighbourhood aging suitability.

### BRIEF SUMMARY OF THE DISCLOSURE

To overcome the defects of the background, the embodiments of the present disclosure provide a method and a system for evaluating neighbourhood aging suitability based on multi-source data fusion to effectively solve the problems involved in the background.

The purposes of the present disclosure can be achieved by adopting the following technical schemes: A method for evaluating neighbourhood aging suitability based on multi-source data fusion, including steps: S1, Detecting a quantity of people entering and leaving a target neighbourhood: by face recognition technology of each housing estate of the target neighbourhood, detecting a quantity of elderly people leaving the each housing estate of the target neighbourhood and a quantity of elderly people entering the each housing estate of the target neighbourhood in a set period.

S2, analyzing traffic suitability of the target neighbourhood: analyzing a mobility suitability coefficient of the elderly people corresponding to the each housing estate of the target neighbourhood, and then analyzing a traffic convenience coefficient JB corresponding to the target neighbourhood accordingly.

S3, evaluating perfection of leisure facilities of the target neighbourhood: obtaining an occupied region of the each housing estate of the target neighbourhood, obtaining an area of the occupied region of the each housing estate of the target neighbourhood, and analyzing a perfection coefficient ω of the leisure facilities corresponding to the target neighbourhood accordingly.

S4, analyzing microenvironment suitability of the target neighbourhood: obtaining environmental parameters of the each housing estate of the target neighbourhood, and then analyzing a microenvironment suitability coefficient HJ corresponding to the target neighbourhood accordingly.

S5, evaluating aging suitability of the target neighbourhood: evaluating an evaluation coefficient of aging residential suitability corresponding to the target neighbourhood; and

S6, processing the target neighbourhood: displaying the evaluation coefficient of aging residential suitability corresponding to the target neighbourhood.

Furthermore, the environmental parameters include a carbon dioxide concentration, a sound decibel, and a PM2.5 value corresponding to each layout point at each detection time point.

Furthermore, the step of detecting a quantity of elderly people leaving the each housing estate of the target neighbourhood and a quantity of elderly people entering the each housing estate of the target neighbourhood in a set period includes methods: obtaining a face image of each elderly people in the each housing estate of the target neighbourhood;

Obtaining a face image collected by each exit of the each housing estate of the target neighbourhood in the set period from a target neighbourhood management office, and analyzing a face image of each elderly people leaving the each housing estate of the target neighbourhood;

Counting a quantity of the face images of the elderly people leaving the each housing estate of the target neighbourhood, and taking the quantity of the face images as a quantity SLᵢ of the elderly people leaving the each housing estate of the target neighbourhood in the set period, wherein i is a serial number of the each housing estate, and i=1, 2, . . . , n; and

In a same way, obtaining a quantity JLᵢ of the elderly people entering the each housing estate of the target neighbourhood in the set period.

Furthermore, the step of analyzing a mobility suitability coefficient of elderly people corresponding to the each housing estate of the target neighbourhood includes: obtaining a quantity αᵢ of residents in the each housing estate of the target neighbourhood, obtaining a quantity βᵢ of the elderly people in the each housing estate of the target neighbourhood from the target neighbourhood management office, and then analyzing a proportion

$${BP}_{i} = \frac{{β}_{i}}{{α}_{i}}$$

of the quantity of the elderly people in the each housing estate of the target neighbourhood;

Comparing the proportion of the quantity of the elderly people in the each housing estate of the target neighbourhood with a proportion range of a quantity of elderly people suitable for leaving in each unit time stored in a cloud database, and selecting a quantity of the elderly people suitable for leaving in the each unit time corresponding to the each housing estate of the target neighbourhood;

Multiplying the quantity of the elderly people suitable for leaving in the each unit time corresponding to the each housing estate with a duration corresponding to the set period to obtain a quantity SY; of the elderly people suitable for leaving corresponding to the each housing estate;

Analyzing a suitability coefficient

$${ε}_{j} = {( e + 1 )}^{( \frac{{SY}_{i}}{1 + \vert {SL}_{i} - {SY}_{i} \vert} )}$$

of the quantity of the elderly people suitable for leaving corresponding to the each housing estate of the target neighbourhood, wherein e is a natural constant;

In a same way, analyzing a suitability coefficient ηᵢ of a quantity of elderly people suitable for entering corresponding to the each housing estate of the target neighbourhood; and;

Comprehensively analyzing the mobility suitability coefficient μᵢ=\sqrt{εᵢ*λ₁+ηᵢ*λ₂} of the elderly people suitable for leaving corresponding to the each housing estate of the target neighbourhood, wherein λ₁ and λ₂ are preset influence weight factors respectively corresponding to the suitability coefficient of the quantity of the elderly people suitable for entering and the suitability coefficient of the quantity of the elderly people suitable for leaving.

Furthermore, the step of analyzing a traffic convenience coefficient corresponding to the target neighbourhood includes: obtaining each bus station and each subway station corresponding to the target neighbourhood from a traffic management center to obtain a center point of the occupied area of each bus station corresponding to the target neighbourhood and a reference point of each subway station corresponding to the target neighbourhood, taking a serial number of the each bus station as 1, 2 . . . , m, . . . , l, and taking a serial number of the each subway station as 1, 2 . . . , p, . . . , q.

Analyzing a traffic distance suitability coefficient ω̅ᵢ corresponding to the each housing estate of the target neighbourhood; and.

Comprehensively analyzing the traffic convenience coefficient

$$JB = ln ( 1 + \frac{1}{n} {\sum }_{i = 1}^{n} {μ}_{i} * {γ}_{1} + \frac{1}{n} {\sum }_{i = 1}^{n} {\overline{ω}}_{i} * {γ}_{2} + σ * {γ}_{3} )$$

corresponding to the target neighbourhood, wherein σ is a traffic line patency coefficient of the target neighbourhood, and γ₁, γ₂ and γ₃ are preset proportion factors respectively corresponding to mobility suitability of elderly people, traffic distance suitability of elderly people, and traffic line patency of elderly people.

Furthermore, a method for analyzing the traffic line patency coefficient σ of the target neighbourhood includes: obtaining a quantity TIₘₖ of nodes of the each bus line corresponding to the each bus station of the target neighbourhood from the target neighbourhood, wherein k is a serial number of the each bus line, k=1, 2, . . . , j.

According to the quantity of the nodes corresponding to the each bus line of the each bus station corresponding to the target neighbourhood, extracting a quantity

$${TI}_{m}^{max}$$

of maximum nodes and a quantity

$${TI}_{m}^{min}$$

of minimum nodes or the each bus station of the target neighbourhood.

Counting a quantity DIₘ of the bus lines of the each bus station of the target neighbourhood.

Obtaining a quantity DYₚ of nodes of the each subway station corresponding to the target neighbourhood.

Analyzing traffic line patency coefficient

$$σ = {χ}_{1} * \frac{1}{l} {\sum }_{m = 1}^{l} ( \frac{1}{j} {\sum }_{k = 1}^{j} \frac{{TI}_{mk}}{{TY}^{′}} ) + {χ}_{2} * {\sum }_{m = 1}^{l} ( \frac{{TI}^{′}}{{TI}_{m}^{max} - {TI}_{m}^{min}} ) + {χ}_{3} * \frac{{DI}_{m}}{1 + {DG}^{′}} + {χ}_{4} * \frac{{DY}_{p}}{1 + {DR}^{′}}$$

of the target neighbourhood, wherein TI′ is a preset allowable error between the quantity of maximum nodes and the quantity of minimum nodes of the bus station, j is a quantity of the bus lines, l is a quantity of bus stations, TY′ is an average value of the quantity of nodes of the bus station corresponding to the target neighbourhood, DG′ is an average value of the quantity of nodes of the bus line corresponding to the target neighbourhood, DR′ an average value of the quantity of nodes of the subway station corresponding to the target neighbourhood, and χ₁, χ₂, χ₃, and χ₄ are preset proportion factors respectively corresponding to the quantity of nodes of the bus line, the quantity of maximum nodes and the quantity of minimum nodes, the quantity of bus lines, and the quantity of nodes of the subway station.

Furthermore, a method for analyzing the leisure facility perfection coefficient corresponding to the target neighbourhood includes: obtaining an area of each leisure facility region corresponding to the target neighbourhood, and then summarizing the area to obtain a total area S of the leisure facility region of the target neighbourhood;

Counting a quantity U of the leisure facility regions corresponding to the target neighbourhood.

Counting an area of the occupied region of the each housing estate of the target neighbourhood, and summarizing the area to obtain a total area S′ of the occupied region of the housing estate of the target neighbourhood.

Extracting a total area SF of the leisure facility regions, a total area SF′ of the occupied regions of the housing estate, and a quantity U′ of the leisure facility regions in a standard aging suitable neighbourhood from a cloud database.

Analyzing the leisure facility perfection coefficient

$$ω = {( \frac{{SF}^{″}}{1 + \vert \frac{S}{{S}^{′}} - \frac{SF}{{SF}^{′}} \vert} * {δ}_{1} + \frac{{U}^{′}}{1 + \vert U - {U}^{′} \vert} * {δ}_{2} )}^{\frac{1}{2}}$$

corresponding to the target neighbourhood, wherein SF″ is a preset allowable error of an area ratio of the leisure facility regions, and δ₁ and δ₂ are preset weight coefficients respectively corresponding to the area ratio of the leisure facility regions and the quantity of the leisure facility regions.

Furthermore, a method for analyzing the microenvironment suitability coefficient corresponding to the target neighbourhood includes: extracting the carbon dioxide concentration, the sound decibel, and the PM2.5 value corresponding to the each layout point at the each detection time point from the environmental parameters of the each housing estate of the target neighbourhood.

according to a predefined range of carbon dioxide concentration, a predefined upper limit of sound decibel, and a predefined range of PM2.5 value corresponding to the standard aging suitable neighbourhood;

According to the sound decibel corresponding to the each layout point of the each housing estate of the target neighbourhood at the each detection time point, analyzing a noise pollution index Zᵢ corresponding to the each housing estate of the target neighbourhood.

According to the carbon dioxide concentration of the each layout point of the each housing estate of the target neighbourhood at the each detection time point and the range of carbon dioxide concentration corresponding to the standard aging suitable neighbourhood, analyzing a carbon dioxide concentration suitability coefficient ϑᵢ corresponding to the each housing estate of the target neighbourhood.

In a same way, according to the PM2.5 value of the each layout point of the each housing estate of the target neighbourhood at the each detection time point, analyzing an air quality Qᵢ index corresponding to the each housing estate of the target neighbourhood.

Analyzing the microenvironment suitability coefficient

$$HJ = \frac{1}{n} {\sum }_{i = 1}^{n} ( e + 1 ) ( \frac{1}{{Z}_{i}} + {ϑ}_{i} + {Q}_{i} )$$

corresponding to the target neighbourhood.

Furthermore, the evaluation coefficient of the aging residential suitability corresponding to the target neighbourhood is calculated by a equation:

$$ψ = {( e - 1 )}^{( JB * {ρ}_{1} + ω * {ρ}_{2} + HJ * {ρ}_{3} )} ,$$

wherein ρ₁, ρ₂, and ρ₃ are preset weight factors respectively corresponding to the traffic suitability, the leisure facility perfection, and the microenvironment suitability.

In a second aspect, the present disclosure provides a system for evaluating neighbourhood aging suitability based on multi-source data fusion, including a target neighbourhood detecting module of a quantity of people entering and leaving, used for detecting a quantity of elderly people leaving each housing estate of a target neighbourhood and a quantity of elderly people entering the each housing estate of the target neighbourhood in a set period, by face recognition technology of the each housing estate of the target neighbourhood;

A target neighbourhood analyzing module of neighbourhood traffic suitability, used for analyzing a mobility suitability coefficient of elderly people corresponding to the each housing estate of the target neighbourhood, and then analyzing a traffic convenience coefficient JB corresponding to the target neighbourhood accordingly;

A target neighbourhood evaluating module of leisure facility perfection, used for obtaining an occupied region of the each housing estate of the target neighbourhood, obtaining an occupied area of each leisure district of the target neighbourhood, and analyzing a leisure facility perfection coefficient ω corresponding to the target neighbourhood accordingly;

A target neighbourhood analyzing module of microenvironment suitability, used for obtaining environmental parameters of the each housing estate of the target neighbourhood, and then analyzing a microenvironment suitability coefficient HJ corresponding to the target neighbourhood accordingly;

A target neighbourhood evaluating module of aging suitability, used for evaluating an evaluation coefficient of aging residential suitability corresponding to the target neighbourhood;

A target neighbourhood processing module, used for displaying the evaluation coefficient of aging residential suitability corresponding to the target neighbourhood; and

A cloud database, used for storing a proportion range of a quantity of elderly people suitable for leaving in each unit time, and storing a total area of leisure facility regions of a standard aging suitable neighbourhood, a total area of the occupied regions of the housing estate of the standard aging suitable neighbourhood, and a quantity of the leisure facility regions of the standard aging suitable neighbourhood.

Compared with the prior art, the present disclosure at least has following advantages or beneficial effects: (1) in the present disclosure, a quantity of the people entering and leaving the target neighbourhood is detected, and then a quantity of the elderly people entering the target neighbourhood and a quantity of the elderly people leaving the target neighbourhood are detected, so as to provide data support for subsequent analysis of neighbourhood traffic convenience.

(2) In the present disclosure, a traveling quantity of elderly people is analyzed to remedy the defect of low attention paid to the traveling quantity of elderly people in the prior art, thereby ensuring the accuracy of the analysis results of neighbourhood traffic convenience, improving the accuracy of neighbourhood aging evaluation to a certain extent, and avoiding a phenomenon that the evaluation of neighbourhood aging suitability is wrong, thereby being beneficial to the correctness and scientificity of subsequent neighbourhood aging suitability transformation and improving the efficiency of neighbourhood aging suitability transformation.

(3) In the present disclosure, not only bus stations and subway stations of the neighbourhood are analyzed, but also bus lines of the neighbourhood bus stations and nodes of the bus lines are comprehensively considered, thereby effectively ensuring that the neighbourhood is located in a region with convenient traffic, avoiding the phenomenon that the neighbourhood has a good bus stop but few bus lines or fewer nodes, which is more conducive to the travel of the elderly, and is conducive to balancing the relationship between neighbourhood traffic convenience and aging suitability, thus improving the accuracy of the analysis results of neighbourhood aging suitability.

(4) In the present disclosure, the leisure facilities in the neighbourhood are analyzed, so that the rationality of the leisure facilities in the neighbourhood is guaranteed, the activities of the elderly in the neighbourhood are facilitated, and the evaluation of the neighbourhood aging suitability is more reasonable.

(5) In the present disclosure, the microenvironment of the neighbourhood is detected and analyzed to ensure that the neighbourhood is suitable for the elderly to live in the air quality level, and meanwhile, to ensure that the noise decibel of the neighbourhood is in a reasonable state, which is more conducive to the physical and mental health of the elderly.

### BRIEF DESCRIPTION OF THE DRAWINGS

The present disclosure is further described herein by using the attached drawings, but embodiments of the drawings do not constitute any restrictions on the present disclosure. For ordinary skilled in the art, other drawings can be obtained according to the following drawings with no inventive labor.

FIG. 1 is a flow chat of a method of the present disclosure.

FIG. 2 is a schematic diagram of module connection of the present disclosure.

### DETAILED DESCRIPTION OF EMBODIMENTS

The technical schemes of the present disclosure are clearly and completely described in combination with the attached drawings in the embodiments of the present disclosure. Obviously, the described embodiments are only a part of embodiments of the present disclosure, not whole embodiments. Based on the embodiments of the present disclosure, all other embodiments obtained by those skilled in the art with no inventive labor should fall within the protection scope of the present disclosure.

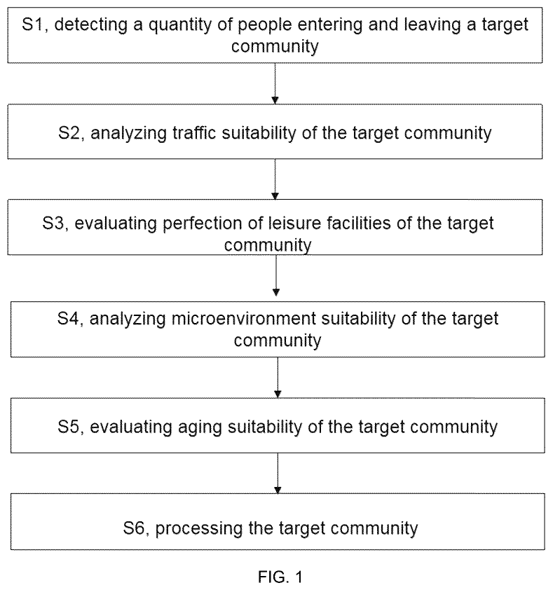

As shown in FIG. 1, the present disclosure provides a method for evaluating neighbourhood aging suitability based on multi-source data fusion, including: S1, detecting a quantity of people entering and leaving a target neighbourhood: by face recognition technology of each housing estate of the target neighbourhood, detecting a quantity of elderly people leaving the each housing estate of the target neighbourhood and a quantity of elderly people entering the each housing estate of the target neighbourhood in a set period.

In a specific embodiment of the present disclosure, the step of detecting a quantity of elderly people leaving the each housing estate of the target neighbourhood and a quantity of elderly people entering the each housing estate of the target neighbourhood in a set period includes obtaining a face image of each elderly people in the each housing estate of the target neighbourhood.

It should be noted that the step of obtaining a face image of each elderly people in the each housing estate of the target neighbourhood includes: obtaining age and a face image of each resident corresponding to the each housing estate from the target neighbourhood; comparing the age of the each resident corresponding to the each housing estate of the target neighbourhood with a predefined age threshold for elderly, and if the age of one resident corresponding to one housing estate of the target neighbourhood is greater than or equal to the age threshold for elderly, marking the one resident as one elderly people, further screening to obtain the each elderly people corresponding to the each housing estate of the target neighbourhood; and obtaining the face image of the each elderly people corresponding to the each housing estate of the target neighbourhood.

Obtaining a face image collected by each exit of the each housing estate of the target neighbourhood in the set period from a target neighbourhood management office, and analyzing the face image of each elderly people leaving the each housing estate of the target neighbourhood.

It should be noted that the step of analyzing the face image of each elderly people leaving the each housing estate of the target neighbourhood includes summarizing the face image collected by the each exit of the each housing estate of the target neighbourhood in the set period to obtain a face image of each leaving people of the each housing estate of the target neighbourhood, and comparing the face image of the each leaving people with the face image of the each elderly people corresponding to the each housing estate of the target neighbourhood, if one face image of the each leaving people of one housing estate of the target neighbourhood is successfully matched with the face image of the each elderly people corresponding to the residential area, marking the one face image as a face image of the leaving elderly people, and then obtaining the face image of the each leaving elderly people of the each housing estate of the target neighbourhood.

Counting a quantity of the face images of the leaving elderly people the each housing estate of the target neighbourhood, and taking the quantity of the face images as a quantity SLᵢ of the leaving elderly people of the each housing estate of the target neighbourhood in the set period, where i is a serial number of the each housing estate, i=1, 2, . . . , n.

In a same way, obtaining a quantity JLᵢ of the entering elderly people of the each housing estate of the target neighbourhood in the set period.

In the present disclosure, a quantity of the people entering and leaving the target neighbourhood is detected, and then a quantity of the elderly people entering the target neighbourhood and a quantity of the elderly people leaving the target neighbourhood are detected, so as to provide data support for subsequent analysis of neighbourhood traffic convenience.

S2, analyzing traffic suitability of the target neighbourhood: analyzing a mobility suitability coefficient of the elderly people corresponding to the each housing estate of the target neighbourhood, and then analyzing a traffic convenience coefficient JB corresponding to the target neighbourhood accordingly.

In a specific embodiment of the present disclosure, a specific method for analyzing a mobility suitability coefficient of the elderly people corresponding to the each housing estate of the target neighbourhood includes: obtaining a quantity αᵢ of residents in the each housing estate of the target neighbourhood from the target neighbourhood management office, obtaining a quantity βᵢ of the elderly people in the each housing estate of the target neighbourhood, and then analyzing a proportion

$${BP}_{i} = \frac{{β}_{i}}{{α}_{i}}$$

of the quantity of the elderly people in the each housing estate of the target neighbourhood.

Comparing the proportion of the quantity of the elderly people in the each housing estate of the target neighbourhood with a proportion range of the quantity of the elderly people corresponding to a quantity of elderly people suitable for leaving in each unit time stored in a cloud database, selecting a quantity of the elderly people suitable for leaving in the each unit time in the each housing estate of the target neighbourhood;

Multiplying the quantity of the elderly people suitable for leaving in the each unit time in the each residential with a duration corresponding to the set period to obtain a quantity SYᵢ of the elderly people suitable for leaving of the each residential.

Analyzing a suitability coefficient

$${ε}_{i} = ( e + 1 ) ( \frac{{SY}_{i}}{1 + \vert {SL}_{i} - {SY}_{i} \vert} )$$

of the quantity of the elderly people leaving corresponding to the each housing estate of the target neighbourhood, where e is a natural constant.

In a same way, analyzing a suitability coefficient ηᵢ of the quantity of elderly people entering corresponding to the each housing estate of the target neighbourhood.

Comprehensively analyzing the mobility suitability coefficient μᵢ=\sqrt{εᵢ*λ₁+ηᵢ*λ₂} of the elder people corresponding to the each housing estate of the target neighbourhood, where λ₁ and λ₂ are influence weight factors respectively corresponding to the preset suitability coefficient of the quantity of the elderly people entering and the preset suitability coefficient of the quantity of the elderly people leaving.

In the present disclosure, a traveling quantity of elderly people is analyzed to remedy the defect of low attention paid to the traveling quantity of elderly people in the prior art, thereby ensuring the accuracy of the analysis results of neighbourhood traffic convenience, improving the accuracy of neighbourhood aging evaluation to a certain extent, and avoiding a phenomenon that the evaluation of neighbourhood aging suitability is wrong, thereby being beneficial to the correctness and scientificity of subsequent neighbourhood aging suitability transformation and improving the efficiency of neighbourhood aging suitability transformation.

In one embodiment of the present disclosure, a specific method for analyzing a traffic convenience coefficient corresponding to the target neighbourhood includes: obtaining each bus station and each subway station both corresponding to the target neighbourhood from a traffic management center, then obtaining both a center point of an occupied region of the each bus station corresponding to the target neighbourhood and a reference point of the each subway station, and taking a serial number of the each bus station as 1, 2 . . . , m, . . . , l, and taking a serial number of the each subway station as 1, 2 . . . , p, . . . , q.

It should be noted that the step of obtaining a reference point of the each subway station corresponding to the target neighbourhood includes: obtaining exposed regions of each entrance and exit of the target neighbourhood corresponding to the each subway station, and then splicing the exposed regions of the each entrance and exit of the target neighbourhood corresponding to the each subway station to obtain a distribution region of the target neighbourhood corresponding to the each subway station, and obtaining a center point of the distribution region of the target neighbourhood corresponding to the each subway station and making the center point of the distribution region as the reference point of the target neighbourhood corresponding to the each subway station.

Analyzing a traffic distance suitability coefficient ω̅ᵢ corresponding to the each housing estate of the target neighbourhood.

It should be noted that the step of analyzing a traffic distance suitability coefficient ω̅ᵢ corresponding to the each housing estate of the target neighbourhood includes: establishing a 3D coordinate system with a center point of the occupied region of the each housing estate of the target neighbourhood as an origin point, then obtaining both a coordinate (xᵢₘ, yᵢₘ, zᵢₘ) of the center point of the occupied region of the target neighbourhood corresponding to the each bus station in the 3D coordinate system corresponding to the each housing estate and a coordinate

$$( {x}_{ip}^{′} , {y}_{ip}^{′} , {z}_{ip}^{′} )$$

of the reference point of the each subway station in the 3D coordinate system corresponding to the each housing estate.

Analyzing a distance JM_{i,m}=\sqrt{xᵢₘ²+yᵢₘ²+zᵢₘ²} between the each housing estate of the target neighbourhood and the each bus stop.

Analyzing a distance

$${JX}_{i , p} = \sqrt{{x}_{ip}^{′2} + {y}_{ip}^{′2} + {z}_{ip}^{′2}}$$

between the each housing estate of the target neighbourhood and the each subway station. Analyzing the traffic distance suitability coefficient

$${ϖ}_{i} = {λ}_{1} * \frac{1}{l} {\sum }_{m = l}^{l} \frac{\frac{1}{q} {\sum }_{p = 1}^{q} {JM}_{i , m}}{1 + {JM}_{i , m}} + {λ}_{2} * \frac{1}{q} {\sum }_{p = 1}^{q} \frac{\frac{1}{q} {\sum }_{p = 1}^{q} {JK}_{i , m}}{1 + {JK}_{i , m}}$$

corresponding to the each housing estate of the target neighbourhood, where l is a quantity of bus stations, q is a quantity of subway stations, and λ₁ and λ₂ are preset influence weight factors respectively corresponding to the distance between a housing estate and a bus station and the distance between a housing estate and a subway station.

Comprehensively analyzing the traffic convenience coefficient

$$JB = ln ( 1 + \frac{1}{n} {\sum }_{i = 1}^{n} {μ}_{i} * {γ}_{1} + \frac{1}{n} {\sum }_{i = 1}^{n} {ϖ}_{i} * {γ}_{2} + σ * {γ}_{3} )$$

corresponding to the target neighbourhood, where σ is a traffic line patency coefficient of the target neighbourhood, and γ₁, γ₂, and γ₃ are preset proportion factors respectively corresponding to mobility suitability of the elderly people, traffic distance suitability, and traffic line patency.

In one embodiment of the present disclosure, a specific method of analyzing the traffic line patency coefficient σ of the target neighbourhood includes obtaining a quantity TIₘₖ of nodes corresponding to each bus line of the target neighbourhood corresponding to the each bus station from the target neighbourhood, where k is a serial number of the each bus line, k=1, 2, . . . , j.

According to the quantity of nodes corresponding to the each bus line of the target neighbourhood corresponding to the each bus station, extracting a quantity

$${TI}_{m}^{max}$$

of maximum nodes and a quantity

$${TI}_{m}^{min}$$

of minimum nodes of the target neighbourhood corresponding to the each bus stopbus station.

Counting a quantity DIₘ of the bus lines of the target neighbourhood corresponding to the each bus station.

Obtaining a quantity DYₚ of nodes of the target neighbourhood corresponding to the each subway station.

Analyzing a traffic line patency coefficient

$$σ = {χ}_{1} * \frac{1}{l} {\sum }_{m = 1}^{l} ( \frac{1}{j} {\sum }_{k = 1}^{j} \frac{{TI}_{mk}}{{TY}^{′}} ) + {χ}_{2} * {\sum }_{m = 1}^{l} ( \frac{{TI}^{′}}{{TI}_{m}^{max} - {TI}_{m}^{min}} ) + {χ}_{3} * \frac{{DI}_{m}}{1 + {DG}^{′}} + {χ}_{4} * \frac{{DY}_{p}}{1 + {DR}^{′}}$$

of the target neighbourhood, where TI′ is a preset allowable error between the quantity of maximum nodes and the quantity of minimum nodes of the bus stop, j is a quantity of bus lines, l is a quantity of bus stops, TY′ is an average value of the quantity of nodes of the bus station corresponding to the target neighbourhood,

$${TY}^{′} = \frac{1}{l} {\sum }_{m = 1}^{l} ( \frac{1}{j} {\sum }_{k = 1}^{j} {TI}_{mk} ) ,$$

DG′ is an average value of the quantity of nodes of the bus line corresponding to the target neighbourhood,

$${DG}^{′} = \frac{1}{l} {\sum }_{m = 1}^{l} {DI}_{m} ,$$

DR′ is average value of the quantity of nodes of the subway station corresponding to the target neighbourhood,

$${DR}^{′} = \frac{1}{l} {\sum }_{m = 1}^{l} {DY}_{m} ,$$

and χ₁, χ₂, χ₃, and λ₄ are preset proportion factors respectively corresponding to the quantity of nodes of the bus line, the quantity of maximum nodes and the quantity of minimum nodes, the quantity of bus lines, and the quantity of nodes of the subway station.

In the present disclosure, not only the bus stations and the subway station of the neighbourhood are analyzed, but also bus lines of the bus stations and a quantity of nodes of the bus line are comprehensively considered, thereby effectively ensuring that the neighbourhood is located in a region with convenient traffic, avoiding the phenomenon that the neighbourhood has a good bus station but few bus lines or fewer nodes, which is more conducive to the travel of the elderly people, and is conducive to balancing the relationship between neighbourhood traffic convenience and aging suitability, thus improving the accuracy of the analysis results of neighbourhood aging suitability.

S3, evaluating perfection of leisure facilities of the target neighbourhood: obtaining an occupied region of the each housing estate of the target neighbourhood, obtaining an area of the occupied region of the each housing estate of the target neighbourhood, and analyzing a perfection coefficient ω of the leisure facilities corresponding to the target neighbourhood accordingly.

It should be noted that the occupied region of the each housing estate of the target neighbourhood is obtained from the target neighbourhood management office.

In one embodiment of the present disclosure, a specific method of analyzing a perfection coefficient of the leisure facilities corresponding to the target neighbourhood includes: obtaining an area of each leisure facility region corresponding to the target neighbourhood, and then summarizing the area to obtain a total area S of the leisure facility region of the target neighbourhood.

It should be noted that the each leisure facility region corresponding to the target neighbourhood is obtained from planning drawings corresponding to the target neighbourhood of the target neighbourhood management office, and then the area of the each leisure facility region corresponding to the target neighbourhood is obtained.

Counting a quantity U of leisure facilities corresponding to the target neighbourhood;

Counting an area of the occupied region of the each housing estate of the target neighbourhood, and summarizing the area to obtain a total area S′ of the occupied region of the housing estate corresponding to the target neighbourhood;

Selecting a total area SF of leisure facility regions, a total area SF′ of the occupied region of the housing estate, a quantity U′ of the leisure facilities in a standard aging suitable neighbourhood from the cloud database;

Analyzing the leisure facility perfection coefficient

$$ω = {( \frac{S {F}^{″}}{1 + \vert \frac{S}{{S}^{′}} - \frac{SF}{{SF}^{′}} \vert} * {δ}_{1} + \frac{{U}^{′}}{1 + \vert U - {U}^{′} \vert} * {δ}_{2} )}^{\frac{1}{2}}$$

corresponding to the target neighbourhood, where SF″ is a preset allowable error of an area ratio of the leisure facilities, and δ₁ and δ₂ are preset weight coefficients respectively corresponding to the area ratio of the leisure facilities and the quantity of the leisure facilities.

In the present disclosure, the leisure facilities in the neighbourhood are analyzed, so that the rationality of the leisure facilities in the neighbourhood is guaranteed, the activities of the elderly in the neighbourhood are facilitated, and the evaluation of the neighbourhood aging suitability is more reasonable.

S4, analyzing microenvironment suitability of the target neighbourhood: obtaining environmental parameters of the each housing estate of the target neighbourhood, and then analyzing a microenvironment suitability coefficient HJ corresponding to the target neighbourhood accordingly.

In one embodiment, the environmental parameters include a carbon dioxide concentration, a sound decibel, and a PM2.5 value corresponding to each layout point at each detection time point.

It should be noted that the environment of the each housing estate of the target neighbourhood is detected by using a carbon dioxide gas detector, a noise detector, and an air quality detector to obtain the carbon dioxide concentration, the sound decibel, and the PM2.5 value of the each housing estate of the target neighbourhood at each layout point in each detection time point.

In one embodiment of the present disclosure, a specific method of analyzing a microenvironment suitability coefficient corresponding to the target neighbourhood includes: selecting the carbon dioxide concentration, the sound decibel, and the PM2.5 value corresponding to the each layout point at the each detection time point from the environmental parameters of the each housing estate of the target neighbourhood;

According to a predefined range of the carbon dioxide concentration, a predefined upper limit of the sound decibel and a predefined range of the PM2.5 value corresponding to the standard aging suitable neighbourhood;

According to the sound decibel corresponding to the each layout point of the each housing estate of the target neighbourhood at the each detection time point, analyzing a noise pollution index Zᵢ corresponding to the each housing estate of the target neighbourhood.

It should be noted that a calculating equation of the noise pollution index Zᵢ corresponding to the each housing estate of the target neighbourhood is

$${Z}_{i} = \frac{1}{d} {\sum }_{f = 1}^{d} [ \frac{1}{t} {\sum }_{c = 1}^{t} {e}^{( \frac{{TF}_{ifc} - {β}^{′}}{{β}^{′}} )} ] ,$$

where TF_{ifc} is the sound decibel corresponding to the f-th layout point of the i-th housing estate of the target neighbourhood at the c-th detection time point; β′ is the upper limit of sound decibel corresponding to the standard aging suitable neighbourhood; f is a serial number of the layout point, f=1, 2, . . . , d; c is a serial number of the detection time point, c=1, 2, . . . , t; d is the quantity of layout points; t is the quantity of detection time points.

According to the carbon dioxide concentration of the each layout point corresponding to the each housing estate of the target neighbourhood at the each detection time point and the range of carbon dioxide concentration corresponding to the standard aging suitable neighbourhood, analyzing a carbon dioxide concentration suitability coefficient ϑᵢ corresponding to the each housing estate of the target neighbourhood.

It should be noted that, comparing the carbon dioxide concentration of the each layout point corresponding to the each housing estate of the target neighbourhood at the each detection time with the range of carbon dioxide concentration corresponding to the standard aging suitable neighbourhood, if the carbon dioxide concentration of the each layout point corresponding to the each housing estate of the target neighbourhood at the each detection time is located in the range of carbon dioxide concentration corresponding to the standard aging suitable neighbourhood, marking the carbon dioxide concentration suitability coefficient of the each layout point corresponding to the each housing estate of the target neighbourhood at the each detection time as φ, otherwise, marking as φ′, and then obtaining the carbon dioxide concentration suitability coefficient ξ_{ifc} of the each layout point corresponding to the each housing estate of the target neighbourhood at the each detection time, where ξ_{ifc}=φ or φ′.

Analyzing the carbon dioxide concentration suitability coefficient

$${ϑ}_{i} = \frac{1}{d} {\sum }_{f = 1}^{d} \frac{1}{t} {\sum }_{c = 1}^{t} {ξ}_{ifc}$$

corresponding to the each housing estate of the target neighbourhood.

In a same way, according to the PM2.5 value of the each layout point corresponding to the each housing estate of the target neighbourhood at the each detection time point, analyzing an air quality index Qᵢ corresponding to the each housing estate of the target neighbourhood.

Analyzing the microenvironment suitability coefficient

$$HJ = \frac{1}{n} {\sum }_{i = 1}^{n} {( e + 1 )}^{( \frac{1}{{Z}_{i}} + {ϑ}_{i} + {Q}_{i} )}$$

corresponding to the target neighbourhood.

In the present disclosure, the microenvironment of the neighbourhood is detected and analyzed to ensure that the neighbourhood is suitable for the elderly to live in the air quality level, and meanwhile, to ensure that the noise decibel of the neighbourhood is in a reasonable state, which is more conducive to the physical and mental health of the elderly.

S5, evaluating aging suitability of the target neighbourhood: evaluating an evaluation coefficient of aging residential suitability corresponding to the target neighbourhood.

In one embodiment, the evaluation coefficient of the aging residential suitability corresponding to the target neighbourhood is calculated by a equation:

$$ψ = {( e - 1 )}^{( JB * {ρ}_{1} + ω * {ρ}_{2} + HJ * {ρ}_{3} )} ,$$

where ρ₁ [symbol] ρ₂ [symbol] ρ₃ are preset weight factors respectively corresponding to the traffic convenience, the leisure facility perfection, and the microenvironment suitability.

S6, processing the target neighbourhood: displaying the evaluation coefficient of the aging residential suitability corresponding to the target neighbourhood.

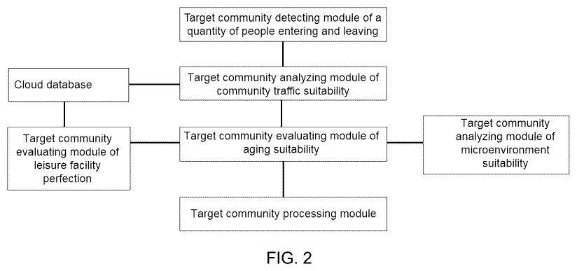

As shown in FIG. 2, in a second aspect, the present disclosure provides a system for evaluating neighbourhood aging suitability based on multi-source data fusion, including a target neighbourhood detecting module of a quantity of people entering and leaving, a target neighbourhood analyzing module of traffic suitability, a target neighbourhood evaluating module of leisure facility perfection, a target neighbourhood analyzing module of microenvironment suitability, a target neighbourhood evaluating module of aging suitability, a target neighbourhood processing module, and a cloud database.

The target neighbourhood detecting module of a quantity of people entering and leaving is connected to the target neighbourhood analyzing module of neighbourhood traffic suitability. The target neighbourhood evaluating module of aging suitability is connected to the target neighbourhood analyzing module of neighbourhood traffic suitability, the target neighbourhood evaluating module of leisure facility perfection, and the target neighbourhood analyzing module of microenvironment suitability, respectively. The target neighbourhood evaluating module of aging suitability is connected to the target neighbourhood processing module. The cloud database is connected to the target neighbourhood analyzing module of neighbourhood traffic suitability and the target neighbourhood evaluating module of leisure facility perfection.

The target neighbourhood detecting module of a quantity of people entering and leaving is used for detecting a quantity of elderly people leaving and a quantity of elderly people entering of each housing estate of the target neighbourhood in a set period, by face recognition technology of the each housing estate of the target neighbourhood.

The target neighbourhood analyzing module of neighbourhood traffic suitability is used for analyzing a mobility suitability coefficient of the elderly people corresponding to the each housing estate of the target neighbourhood, and then analyzing a traffic convenience coefficient JB corresponding to the target neighbourhood accordingly.

The target neighbourhood evaluating module of leisure facility perfection is used for obtaining an occupied region of the each housing estate of the target neighbourhood, obtaining an area of the occupied region of the each housing estate corresponding to the target neighbourhood, and analyzing a perfection coefficient ω of leisure facilities corresponding to the target neighbourhood accordingly.

The target neighbourhood analyzing module of microenvironment suitability is used for obtaining environmental parameters of the each housing estate of the target neighbourhood, and then analyzing a microenvironment suitability coefficient HJ corresponding to the target neighbourhood accordingly.

The target neighbourhood evaluating module of aging suitability is used for evaluating an evaluation coefficient of aging residential suitability corresponding to the target neighbourhood.

The target neighbourhood processing module is used for displaying the evaluation coefficient of the aging residential suitability corresponding to the target neighbourhood.

The cloud database is used for storing a proportion range of a quantity of elderly people suitable for leaving in each unit duration, and storing a total area of leisure facility regions, a total area of the occupied region of the housing estate, and a quantity of the leisure facility regions in a standard aging suitable neighbourhood.

Finally, it should be noted that the above are only better embodiments of the present disclosure. Those skilled in the art should understand that they may still modify the technical scheme described in the aforementioned embodiments or replace some of the technical features equally; these various modifications, supplements or substitutions in a similar way, as long as they do not deviate from the methods of the present disclosure or exceed the scope defined by the present disclosure, should belong to the protection scope of the present disclosure.

1-10. (canceled)

11. A method for evaluating neighbourhood aging suitability based on multi-source data fusion, comprising:
S1, detecting a quantity of people entering and leaving a target neighbourhood by face recognition technology of each housing estate of the target neighbourhood, and detecting a quantity of elderly people leaving each housing estate of the target neighbourhood and a quantity of elderly people entering each housing estate of the target neighbourhood in a set period;
S2, analyzing traffic suitability of the target neighbourhood: analyzing a mobility suitability coefficient of the elderly people corresponding to each housing estate of the target neighbourhood, and then analyzing a traffic convenience coefficient JB corresponding to the target neighbourhood accordingly;
S3, evaluating perfection of leisure facilities of the target neighbourhood: obtaining an occupied region of each housing estate of the target neighbourhood, obtaining an area of the occupied region of each housing estate of the target neighbourhood, and analyzing a perfection coefficient ω of the leisure facilities corresponding to the target neighbourhood accordingly;
S4, analyzing microenvironment suitability of the target neighbourhood: obtaining environmental parameters of each housing estate of the target neighbourhood, and then analyzing a microenvironment suitability coefficient HJ corresponding to the target neighbourhood accordingly;
S5, evaluating aging suitability of the target neighbourhood: evaluating an evaluation coefficient of aging residential suitability corresponding to the target neighbourhood; and
S6, processing the target neighbourhood: displaying the evaluation coefficient of aging residential suitability corresponding to the target neighbourhood.

12. The method for evaluating neighbourhood aging suitability based on multi-source data fusion according to claim 1, wherein the environmental parameters comprise a carbon dioxide concentration, a sound decibel, and a PM2.5 value corresponding to each layout point at each detection time point.

13. The method for evaluating neighbourhood aging suitability based on multi-source data fusion according to claim 1, wherein the step of detecting a quantity of elderly people leaving each housing estate of the target neighbourhood and a quantity of elderly people entering each housing estate of the target neighbourhood in a set period comprises:
obtaining a face image of each elderly people in each housing estate of the target neighbourhood;
obtaining a face image collected by each exit of each housing estate of the target neighbourhood in the set period from a target neighbourhood management office, and analyzing a face image of each elderly people leaving each housing estate of the target neighbourhood;
counting a quantity of the face images of the elderly people leaving each housing estate of the target neighbourhood, and taking the quantity of the face images as a quantity SLᵢ of the elderly people leaving each housing estate of the target neighbourhood in the set period, wherein i is a serial number of each housing estate, and i=1, 2, . . . , n; and
in a same way, obtaining a quantity JLᵢ of the elderly people entering each housing estate of the target neighbourhood in the set period.

14. The method for evaluating neighbourhood aging suitability based on multi-source data fusion according to claim 3, wherein the step of analyzing a mobility suitability coefficient of elderly people corresponding to each housing estate of the target neighbourhood comprises:
obtaining a quantity αᵢ of residents in each housing estate of the target neighbourhood,
obtaining a quantity βᵢ of the elderly people in each housing estate of the target neighbourhood from the target neighbourhood management office, and then analyzing a proportion
$${BP}_{i} = \frac{{β}_{i}}{{α}_{i}}$$
of the quantity of the elderly people in each housing estate of the target neighbourhood;
comparing the proportion of the quantity of the elderly people in each housing estate of the target neighbourhood with a proportion range of a quantity of elderly people suitable for leaving in each unit time stored in a cloud database, and selecting a quantity of the elderly people suitable for leaving in each unit time corresponding to each housing estate of the target neighbourhood;
multiplying the quantity of the elderly people suitable for leaving in each unit time corresponding to each housing estate with a duration corresponding to the set period to obtain a quantity SYᵢ of the elderly people suitable for leaving corresponding to each housing estate; analyzing a suitability coefficient
$${ε}_{i} = {( e + 1 )}^{( \frac{{SY}_{i}}{1 + \vert {SL}_{i} - {SY}_{i} \vert} )}$$
of the quantity of the elderly people suitable for leaving corresponding to each housing estate of the target neighbourhood, wherein e is a natural constant;
in a same way, analyzing a suitability coefficient ηᵢ of a quantity of elderly people suitable for entering corresponding to each housing estate of the target neighbourhood; and
comprehensively analyzing the mobility suitability coefficient μᵢ=\sqrt{εᵢ*λ₁+ηᵢ*λ₂} of the elderly people suitable for leaving corresponding to each housing estate of the target neighbourhood, wherein λ₁ and λ₂ are preset influence weight factors respectively corresponding to the suitability coefficient of the quantity of the elderly people suitable for entering and the suitability coefficient of the quantity of the elderly people suitable for leaving.

15. The method for evaluating neighbourhood aging suitability based on multi-source data fusion according to claim 1, wherein the step of analyzing a traffic convenience coefficient corresponding to the target neighbourhood comprises:
obtaining each bus station and each subway station corresponding to the target neighbourhood from a traffic management center to obtain a center point of the occupied area of each bus station corresponding to the target neighbourhood and a reference point of each subway station corresponding to the target neighbourhood, taking a serial number of each bus station as 1, 2 . . . , m, . . . , l, and taking a serial number of each subway station as 1, 2 . . . , p, . . . , q;
analyzing a traffic distance suitability coefficient ω̅ᵢ corresponding to each housing estate of the target neighbourhood; and
comprehensively analyzing the traffic convenience coefficient
$$JB = ln ( 1 + \frac{1}{n} {\sum }_{i = 1}^{n} {μ}_{i} * {γ}_{1} + \frac{1}{n} {\sum }_{i = 1}^{n} {\overline{ω}}_{i} * {γ}_{2} + σ * {γ}_{3} )$$
corresponding to the target neighbourhood, wherein σ is a traffic line patency coefficient of the target neighbourhood, and γ₁, γ₂ and γ₃ are preset proportion factors respectively corresponding to mobility suitability of elderly people, traffic distance suitability of elderly people, and traffic line patency of elderly people.

16. The method for evaluating neighbourhood aging suitability based on multi-source data fusion according to claim 5, wherein a method for analyzing the traffic line patency coefficient σ of the target neighbourhood comprises:
obtaining a quantity TIₘₖ of nodes of each bus line corresponding to each bus station of the target neighbourhood from the target neighbourhood, wherein k is a serial number of each bus line, k=1, 2, . . . , j;
according to the quantity of the nodes corresponding to each bus line of each bus station corresponding to the target neighbourhood, extracting a quantity
$${TI}_{m}^{max}$$
of maximum nodes and a quantity
$${TI}_{m}^{min}$$
of minimum nodes of each bus station of the target neighbourhood;
counting a quantity DIₘ of the bus lines of each bus station of the target neighbourhood;
obtaining a quantity DYₚ of nodes of each subway station corresponding to the target neighbourhood;
analyzing the traffic line patency coefficient
$$σ = {χ}_{1} * \frac{1}{l} {\sum }_{m = 1}^{l} ( \frac{1}{j} {\sum }_{m = 1}^{j} \frac{{TI}_{k}}{TY} ) + {χ}_{2} * {\sum }_{m = 1}^{l} ( \frac{{TI}^{′}}{{TI}_{m}^{max} - {TI}_{m}^{min}} ) + {χ}_{3} * \frac{{DI}_{m}}{1 + {DG}^{′}} + {χ}_{4} * \frac{{DY}_{p}}{1 + {DR}^{′}}$$
of the target neighbourhood, wherein TI′ is a preset allowable error between the quantity of maximum nodes and the quantity of minimum nodes of the bus station, j is a quantity of the bus lines, l is a quantity of bus stations, TY′ is an average value of the quantity of nodes of the bus station corresponding to the target neighbourhood, DG′ is an average value of the quantity of nodes of the bus line corresponding to the target neighbourhood, DR′ an average value of the quantity of nodes of the subway station corresponding to the target neighbourhood, and χ₁, χ₂, χ₃, and χ₄ are preset proportion factors respectively corresponding to the quantity of nodes of the bus line, the quantity of maximum nodes and the quantity of minimum nodes, the quantity of bus lines, and the quantity of nodes of the subway station.

17. The method for evaluating neighbourhood aging suitability based on multi-source data fusion according to claim 1, wherein a method for analyzing the leisure facility perfection coefficient corresponding to the target neighbourhood comprises:
obtaining an area of each leisure facility region corresponding to the target neighbourhood, and then summarizing the area to obtain a total area S′ of the leisure facility region of the target neighbourhood;
counting a quantity U of the leisure facility regions corresponding to the target neighbourhood;
counting an area of the occupied region of each housing estate of the target neighbourhood, and summarizing the area to obtain a total area S′ of the occupied region of the housing estate of the target neighbourhood;
extracting a total area SF of the leisure facility regions, a total area SF′ of the occupied regions of the housing estate, and a quantity U′ of the leisure facility regions in a standard aging suitable neighbourhood from a cloud database; and
analyzing the leisure facility perfection coefficient
$$ω = {( \frac{S {F}^{″}}{1 + \vert \frac{S}{{S}^{′}} - \frac{SF}{{SF}^{′}} \vert} * {δ}_{1} + \frac{{U}^{′}}{1 + \vert U - {U}^{′} \vert} * {δ}_{2} )}^{\frac{1}{2}}$$
corresponding to the target neighbourhood, wherein SF″ is a preset allowable error of an area ratio of the leisure facility regions, and δ₁ and δ₂ are preset weight coefficients respectively corresponding to the area ratio of the leisure facility regions and the quantity of the leisure facility regions.

18. The method for evaluating neighbourhood aging suitability based on multi-source data fusion according to claim 2, wherein a method for analyzing the microenvironment suitability coefficient corresponding to the target neighbourhood comprises:
extracting the carbon dioxide concentration, the sound decibel, and the PM2.5 value corresponding to each layout point at each detection time point from the environmental parameters of each housing estate of the target neighbourhood;
according to a predefined range of carbon dioxide concentration, a predefined upper limit of sound decibel, and a predefined range of PM2.5 value corresponding to the standard aging suitable neighbourhood;
according to the sound decibel corresponding to each layout point of each housing estate of the target neighbourhood at each detection time point, analyzing a noise pollution index Zᵢ corresponding to each housing estate of the target neighbourhood;
according to the carbon dioxide concentration of each layout point of each housing estate of the target neighbourhood at each detection time point and the range of carbon dioxide concentration corresponding to the standard aging suitable neighbourhood, analyzing a carbon dioxide concentration suitability coefficient ϑᵢ corresponding to the each housing estate of the target neighbourhood;
in a same way, according to the PM2.5 value of each layout point of each housing estate of the target neighbourhood at each detection time point, analyzing an air quality index Qᵢ corresponding to each housing estate of the target neighbourhood; and
analyzing the microenvironment suitability coefficient
$$HJ = \frac{1}{n} {\sum }_{i = 1}^{n} {( e + 1 )}^{( \frac{1}{{Z}_{i}} + {ϑ}_{i} + {Q}_{i} )}$$
corresponding to the target neighbourhood.

19. The method for evaluating neighbourhood aging suitability based on multi-source data fusion according to claim 1, wherein the evaluation coefficient of the aging residential suitability corresponding to the target neighbourhood is calculated by a equation:
$$ψ = {( e - 1 )}^{( JB * {ρ}_{1} + ω * {ρ}_{2} + HJ * {ρ}_{3} )} ,$$
wherein ρ₁, ρ₂, and ρ₃ are preset weight factors respectively corresponding to the traffic suitability, the leisure facility perfection, and the microenvironment suitability.

20. A system for evaluating neighbourhood aging suitability based on multi-source data fusion, comprising:
a target neighbourhood detecting module of a quantity of people entering and leaving, used for detecting a quantity of elderly people leaving each housing estate of a target neighbourhood and a quantity of elderly people entering each housing estate of the target neighbourhood in a set period, by face recognition technology of each housing estate of the target neighbourhood;
a target neighbourhood analyzing module of neighbourhood traffic suitability, used for analyzing a mobility suitability coefficient of elderly people corresponding to each housing estate of the target neighbourhood, and then analyzing a traffic convenience coefficient JB corresponding to the target neighbourhood accordingly;
a target neighbourhood evaluating module of leisure facility perfection, used for obtaining an occupied region of each housing estate of the target neighbourhood, obtaining an occupied area of each leisure district of the target neighbourhood, and analyzing a leisure facility perfection coefficient ω corresponding to the target neighbourhood accordingly;
a target neighbourhood analyzing module of microenvironment suitability, used for obtaining environmental parameters of each housing estate of the target neighbourhood, and then analyzing a microenvironment suitability coefficient HJ corresponding to the target neighbourhood accordingly;
a target neighbourhood evaluating module of aging suitability, used for evaluating an evaluation coefficient of aging residential suitability corresponding to the target neighbourhood;
a target neighbourhood processing module, used for displaying the evaluation coefficient of aging residential suitability corresponding to the target neighbourhood; and
a cloud database, used for storing a proportion range of a quantity of elderly people suitable for leaving in each unit time, and storing a total area of leisure facility regions of a standard aging suitable neighbourhood, a total area of the occupied regions of the housing estate of the standard aging suitable neighbourhood, and a quantity of the leisure facility regions of the standard aging suitable neighbourhood.
